(19) United States
(12) Patent Application Publication
(10) Pub. No.: US 2004/0199900 A1
(43) Pub. Date: Oct. 7, 2004

(54) Management system

(76) Inventors: Simon Wild, New South Wales (AU); Donald James McLean, New South Wales (AU)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/487,189

(22) PCT Filed: Aug. 22, 2002
(86) PCT No.: PCT/AU02/01128

(30) Foreign Application Priority Data
Aug. 22, 2001 (AU) PR 7177

(51) Int. Cl. G06F 9/44

(52) U.S. Cl. 717/120; 717/104

(57) ABSTRACT

A management system and corresponding management method are described which operate by defining a system or process as a number of discreet elements; defining relationships between the elements; changing the other elements according to the defined relationships when a change is made to an element of the system or process, or a further element is added; and storing the previous version of an element when an element is changed. A history of changes is maintained which allows the history of operation of the system or process to be statically analysed.

### FIELD OF THE INVENTION

The present invention relates to a management system.

### BACKGROUND TO THE INVENTION

The operation of many processes or systems requires the interaction of many parts of the process or system. For instance, a team of engineers in a software company who are working as a team on a project to produce a software product must keep up to date of changes to the project requirements. These changes may include changes to the customer's requirements and changes to the test requirements of the product. Failure of the members of the team to keep up to date with these changes leads to overruns in both costs to complete and time to complete the project.

Further, if an organization has in place a management system that defines procedures that the organization should follow, this typically takes the form of a series of printed manuals that are kept in the office of the person in that organization who is responsible for the management system and are not readily available to persons within the organization. Alternatively, such a management system may take the form of web pages stored on a company intranet or the like. Experience has shown that people do not regularly consult these types of web pages. As a result, members of the organization are commonly not familiar with the procedures that they are required to follow.

Further, different members of an organization will follow specified procedures to a greater or lesser extent even when given the same education to make them aware of the procedures. This leads to inconsistent activities by members of the organization, which can lead to duplication of work or other resource wasting outcomes, making errors and omitting to perform necessary and required work.

In an organization, data is typically stored in a variety of formats such as word processor documents or spreadsheets and these are typically stored in a variety of places such as on a users hard drive, or on an intranet or a mixture of these. Further, some data relating to the organization is not stored at all. This makes it difficult to effectively monitor and manage the operation of the organization.

There currently exist quality management systems and process models such as those specified under ISO9000, ISO15504, ISO 12207, SEI CMM and related specifications. However, whilst such standards assist in imposing structure on management systems associated with projects it is still the case that they require a massive amount of manual work to implement and further manual updating is required as changes are made. Thus, such systems are time consuming and hence expensive to implement.

### SUMMARY OF THE INVENTION

In a first aspect the present invention provides a system for managing a system or process including means for defining the system or process as a number of discrete elements; means for defining relationships between the elements; means for changing other elements according to the defined relationships when a change is made to an element of the system or process, or a further element is added; and means for storing the previous version of an element when the element is changed.

In this way, a system or process is defined in a rational manner and dependent relationships between elements of the system are defined. If a change is made to an element of the system or process that impacts upon other elements, these other elements are systematically changed. A history of changes is maintained which allows the history of operation of the system or process to be analyzed.

Preferably, the relationships define whether changes to the other elements must be reviewed by a human operator. Changes are made systematically either automatically by computer, or manually with human intervention. In this way, important consequential changes to elements of the system can be reviewed by a skilled operator before being implemented.

Preferably, the elements are objects which include attributes. This provides a rational data structure that is easily interpreted by a computing system.

Preferably, each relationship is stored as an attribute of an object.

Preferably, the system further includes confining means for confining the operation of the managed system or process within the defined system or process. By doing this, the system or process operates within defined parameters.

Preferably, the confining means confines a user to undertaking activities in line with their responsibilities in the managed system or process.

Preferably, the confining means confines a user to enter data only in defined fields of a form. This allows data to be collected from operators in a structured fashion.

Preferably, the system further includes means for analysing the elements and previous versions of elements and representing them statistically or in a graphical format. This provides useful management information that can be used as feedback to modify the definition of the system or process.

In a second aspect the present invention provides a method of managing a system or process including the steps of defining the system or process as a number of discrete elements; defining relationships between the elements; changing the other elements according to the defined relationships when a change is made to an element of the system or process, or a further element is added; and

storing the previous version of an element when an element is changed.

Preferably, the relationships define whether the changes to the other elements must be reviewed by a human operator.

Preferably, the elements are stored as objects which include attributes.

Preferably, the relationship is stored as an attribute of an object.

Preferably, the method further includes the step of confining the operation of the managed system or process within the defined system or process.

Preferably, the step of confining the operation of the system includes the step of confining a user to undertaking activities in line with their responsibilities in the defined system or process.

Preferably, the step of confining the operation of the system or process includes the step of confining a user to enter data only in defined fields of a form.

Preferably, the method further includes the step of analysing the elements and previous versions of elements and representing them statistically or in a graphical format.

In a third aspect the present invention provides a computer software program arranged to instruct a computing system to operate in accordance with a system according to the first aspect of the invention.

In a fourth aspect the present invention provides a computer readable medium carrying a computer software program in accordance with the third aspect of the invention.

### BRIEF DESCRIPTION OF DRAWINGS

Embodiments of the present invention will now be described with reference to the accompanying drawings wherein:

FIG. 1 is a block diagram of a basic data structure for use in accordance with a first embodiment of the present invention;

FIG. 2 is a logic flow diagram of utilisation of the data structure of FIG. 1 in accordance with aspects of a first preferred embodiment of the present invention;

FIG. 3 is a block diagram of typical data structure interrelationships achievable with the data structure of FIG. 1;

FIG. 4 is a block diagram of a management system structure in accordance with a first example of the present invention;

FIG. 5 is a block diagram of objects and their interrelationships suitable for use with the management system structure of the first example of FIG. 4;

FIG. 6 is a block diagram of data presentation in the form of documents, as typically used by people, derived from the objects stored or residing in a computer and object interrelationship structure of FIG. 5;

FIG. 7 illustrates the documents of FIG. 6 in greater detail in terms of practical examples;

FIG. 8 illustrates a first particular graphical presentation of metrics derivable from the system of the first example of FIG. 5;

FIG. 9 illustrates a second graphical example of metrics derivable from the first example of the system of FIG. 5;

FIG. 10 is a third graphical representation of metrics derivable from the system of example 1 of FIG. 5 and related diagrams;

FIG. 11 is a block diagram of a management system and a process model's activities in accordance with a second example of the present invention applied to a software engineering project;

FIG. 12 is a schematic view of a process defined by an embodiment of the present invention as it is presented to a user of the system;

FIG. 13 is a schematic view of the process defined in FIG. 12 as presented to another user with a different role in the organisation;

FIG. 14 is an illustration of a screen of an embodiment of the present invention and informs a user of the tasks or requests that have been assigned to them; and

FIG. 15 is a schematic view of elements and their relationships as defined by an embodiment of the present invention.

### DETAILED DESCRIPTION OF PREFERRED EMBODIMENTS

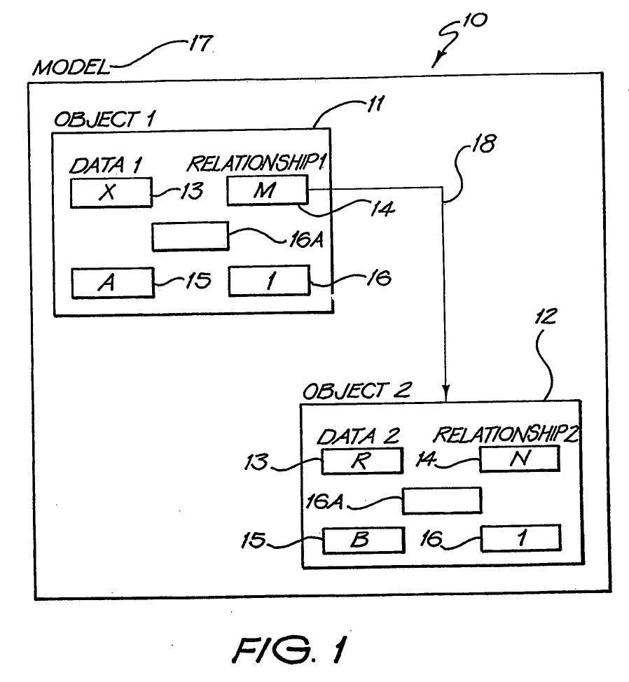

Referring to FIG. 1 the basic data structure upon which embodiments of the system operate will be explained. There is illustrated data structure 10 comprised of a plurality of elements being objects, in this case first object 11 and second object 12.

The objects 11, 12 must include attributes such as version and originator and must include an object identifier, in this instance the attributes 15,16 and 16A respectively. Also, each of the objects 11, 12 must include at least a data attribute 13 and/or a relationship attribute 14.

The objects 11, 12 exist within and according to a consistent structured object model 17 defined by meta-objects, being objects themselves. The model 17, inter alia, defines and dictates the nature of the objects, such as 11, 12 and thereby the potential relationships, including relationship 18 between objects 11, 12.

In the event that the data x in data attribute 13 of first object 11 changes then, by virtue of relationship 18 it may follow that consequential changes may need to be made to data R in data attribute 13 of second object 12.

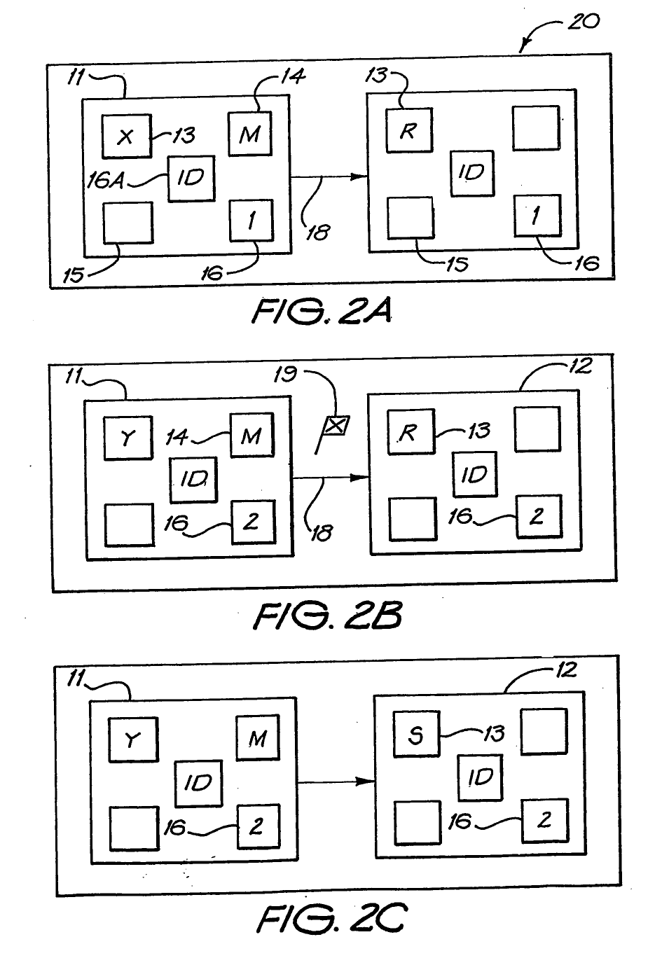

FIG. 2 is a logic flow diagram illustrating the steps to be followed by data structure 10 in the event that data X in data attribute 13 of first object 11 is changed to data Y. Initially, with reference to FIG. 2A first object 11 and second object 12 contain data as illustrated including data X in data attribute 13 of first object 11 and data R in data attribute 13 of second object 12. Relationship data M specifies that relationship 18 exists between first object 11 and second object 12. The objects 11, 12 include originator data in first additional attribute 15 and version data in second additional attribute 16.

In the event that data X in data attribute 13 of first object 11 is changed to data Y therein as illustrated in FIG. 2B of FIG. 2 then relationship data 14 may indicate that a change or check flag 19 is to be set to indicate to management system 20 that a consequential change may need to be made to data R in data attribute 13 of second object 12. In this example, check flag 19 is set.

Once check flag 19 is set then a person who is relevant in the context of the system checks the relationship 18 as specified by data M in relationship attribute 14 of first object 11 and, if as determined by that relationship a consequential change is to be made, then does so in accordance with their professional judgement so as to change data R to data S in data attribute 13 of second object 12 as shown in FIG. 2C of FIG. 2.

Version information is recorded in attribute 16. As a consequence of data attribute 13 information being updated the version information is updated. In this example, from version “1” to version “2”. A new version of object 12 is created (being a new member of the version tree of that object), as illustrated in the final outcome of step 2C.

With the checking process complete, regardless of whether or not a new version of 12 has been generated, the check flag 19 is reset and the system 20 continues.

In this embodiment, as a consequence of the consistently structured object model, the “versioning” of the objects and the linkage between the objects and the monitoring of the linkages, it is possible to build a data store of all activities across a project which is subject to management system 20 of the first embodiment and thereby to derive detailed metrics concerning the project as will be described below with reference to the first example.

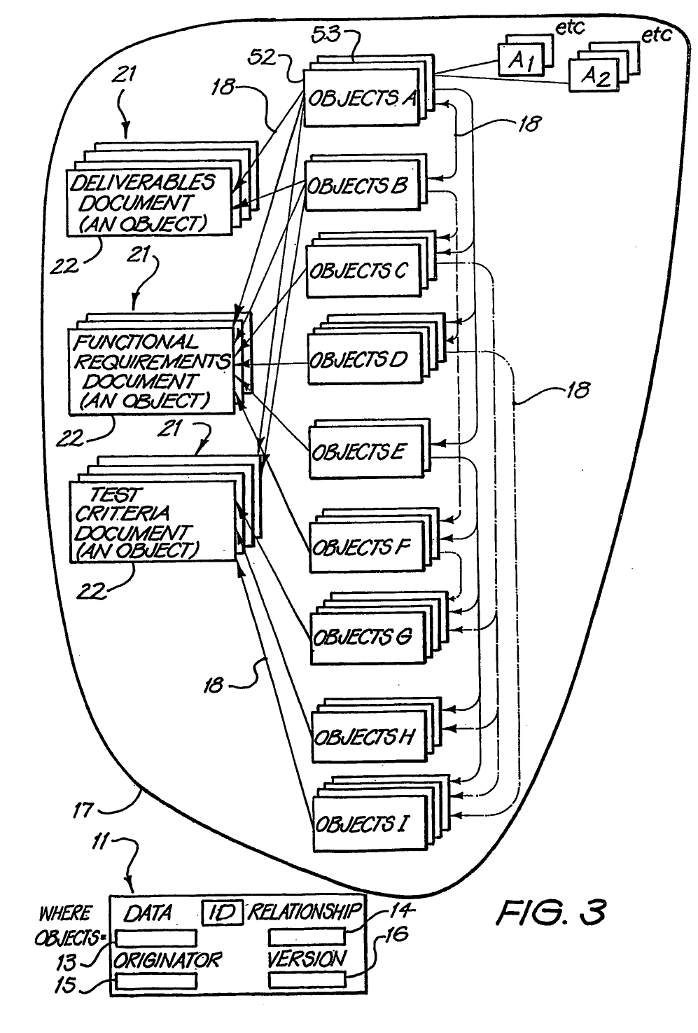

It will be appreciated, and as illustrated in FIG. 3, that the simple data structure 10 which comprises only two objects can readily be extended to systems comprised of many more objects and wherein the data in respective ones of the objects can be linked into other objects to form composite objects 21. In addition, relationships such as relationship 18 can be defined which link multiple objects and/or multiple groupings of objects or composite objects. This data structure can be achieved using XML techniques.

In a specific example as will be described later the objects 52, 53 (being versions of the same object) can be linked into composite objects 21 (here shown as version trees of objects) having the appearance of documents 22 either when viewed on a computer video output or in printed form output from a computer system which implements management system 20.

In a specific example the documents 22 may define project deliverables, project functional requirements and project test criteria.

### EXAMPLE 1

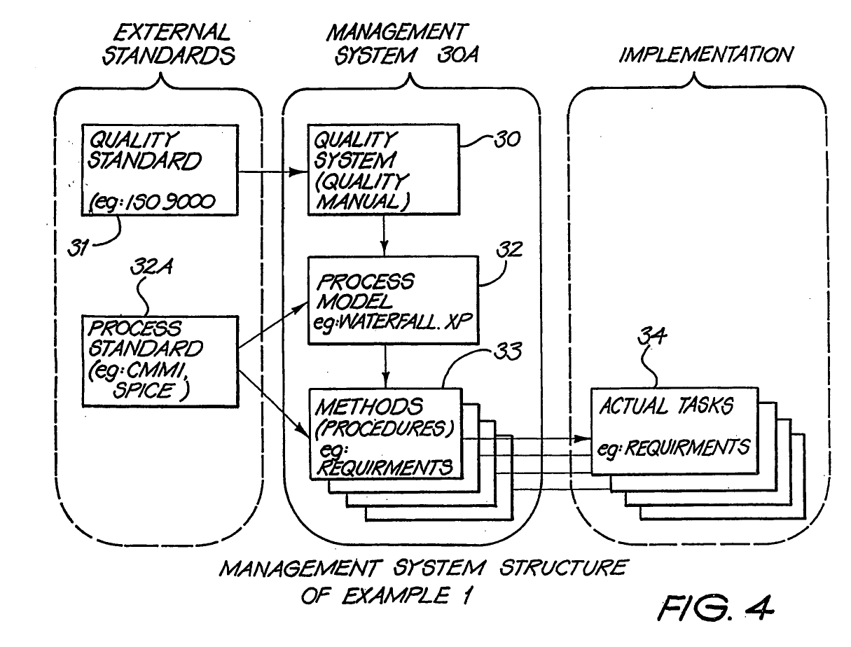

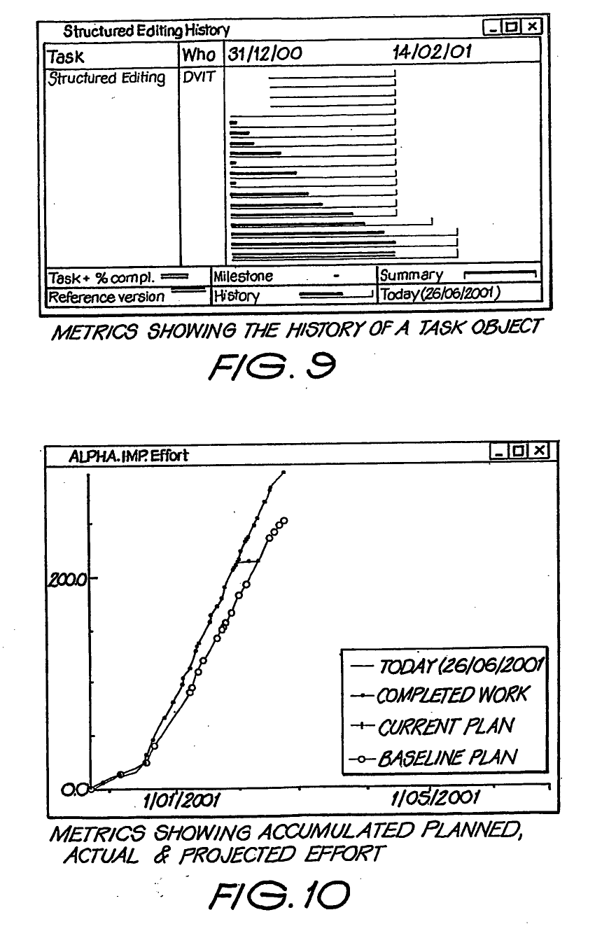

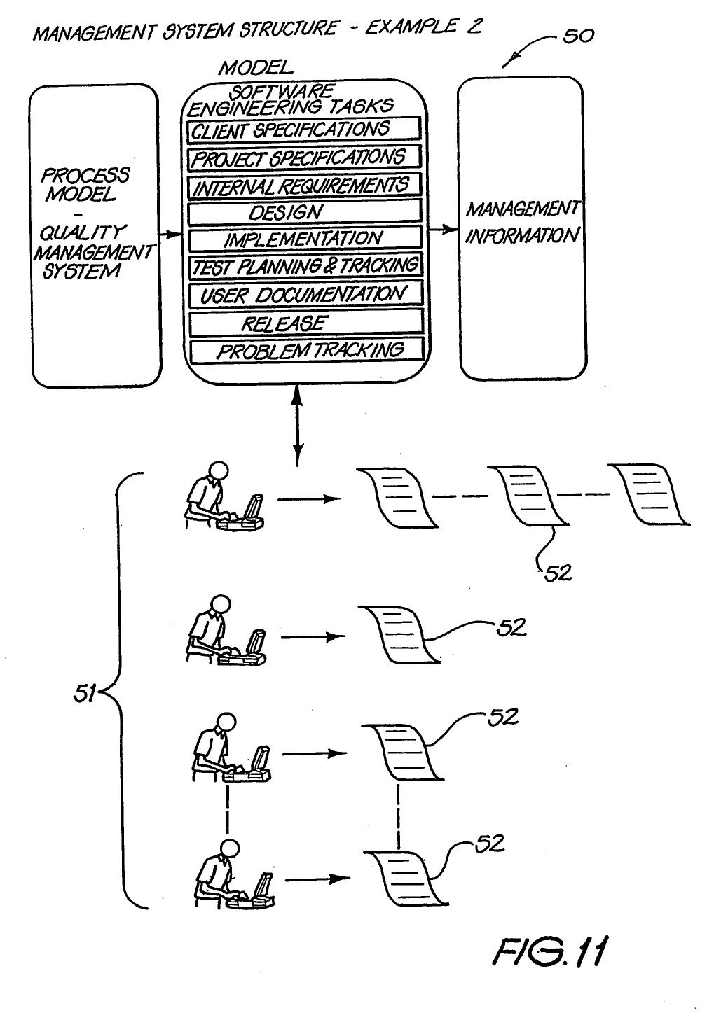

With reference to FIGS. 4 to 10 a first example of a management system 30A based on the management system 20 of the first embodiment described above will itself now be described.

In this instance, example 1 comprises a management system 30A intended to manage progress in a software project.

With reference to FIG. 4 the system 30A may be specified to operate broadly under a quality standard 31 and/or a process standard 32A such as, for example, ISO 9000 and ISO 15504 (respectively) and, broadly, must conform to a user specified process model 32.

The process model 32 dictates the methods 33 by which the project managed by the management system 30A, consisting of quality system 30, process model 32 and methods 33, is to progress and the relationship between the specific or actual tasks 34 which will need to be-performed in order to progress the project from start to finish.

In this example, process model 32 and methods 33 are used by management system 30A to define, maintain and handle change control and linkage of information in the actual tasks 34 and process 32A is used to set the process standards used in the management system structure.

With reference to FIG. 4, the project managed by management system 30A proceeds by the preparation of a plurality of documents defined and dictated by process model 32, process standards 32A and methods 33, such as requirements documents, deliverables documents, etc.

The data contained in all these documents is broken down by defining discrete elements of the project and the relationships between these elements are also defined. The elements are objects. The objects comprise data located in data attributes 13 of objects of the type previously described with reference to FIG. 1 and further including originator or user attributes 15 and version data in version attributes 16.

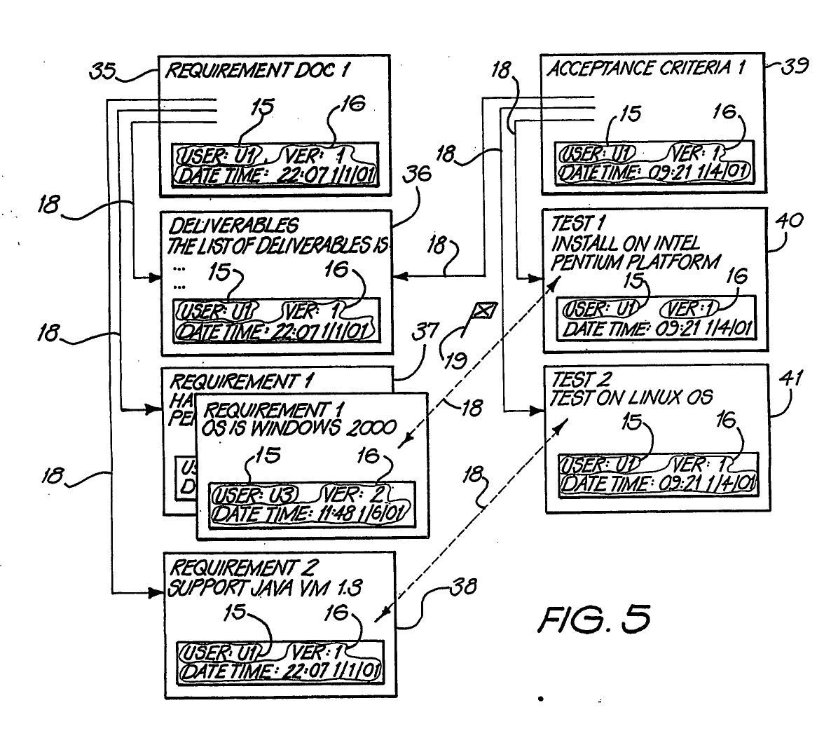

Thus, in FIG. 5, document 35 is composed of a plurality of objects being objects 36, 37 and 38. Similarly, document 39 is composed of objects 36, 40 and 41. This structure can be expanded many times beyond the limited number shown in the Figure.

Further in this specification the concept of “granularity” is referred to and in this specification is a reference to the degree to which each document or other object grouping is comprised of objects.

A high level of granularity would be inferred where each word in each document comprises a data attribute in its own object with the result that there are as many objects as there are words in the document. Conversely a low level of granularity would be implied, where for example, each of the document comprises a data attribute in an object whereby there will only be one object as for that particular document.

In the first example, as illustrated in FIG. 5, relationships between objects are identified as relationships 18 and the data in relationship attributes 14 (refer FIG. 1) of the objects comprising the various documents define the interdependencies between the data attributes of the corresponding documents. So, for example, a relationship 18 exists between objects in the specific software support element 38 and the software test element 41. Similarly, there are interdependencies/relationships 18 between objects in the acceptance criteria element 39, the hardware platform element 40, the software test element 41 and the deliverables element 36.

All of these interdependencies/relationships 18 may be defined by and with reference to the process model 32 and process standard 32A of FIG. 4 or else, and more commonly, by the user of the system.

As previously described with reference to the first embodiment, should data changes in the various data attributes 13 occur then check flags 19 may be set where relationships 18 are defined in the relationship attributes 14 of those objects whereupon the system logs the occurrence of the setting of the check flags and allows consequential changes to be made to data and updating versioning attributes as previously described generally with reference to FIG. 2.

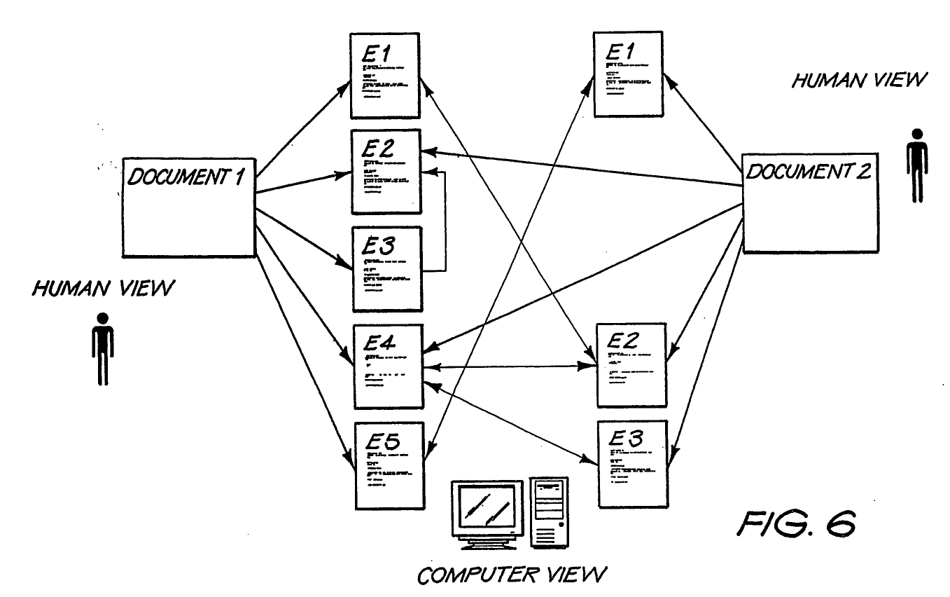

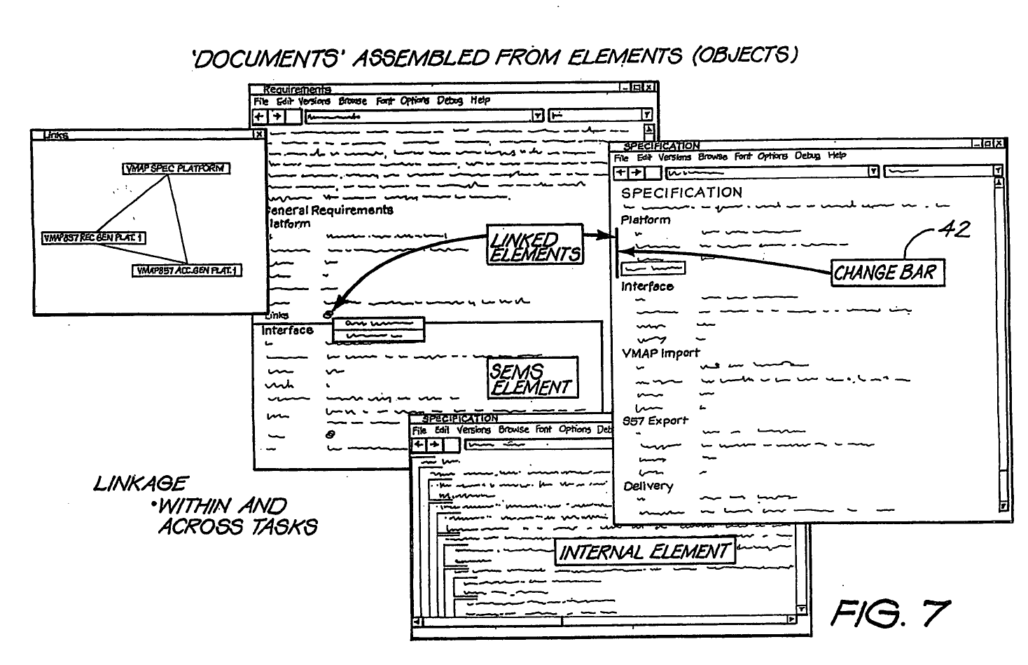

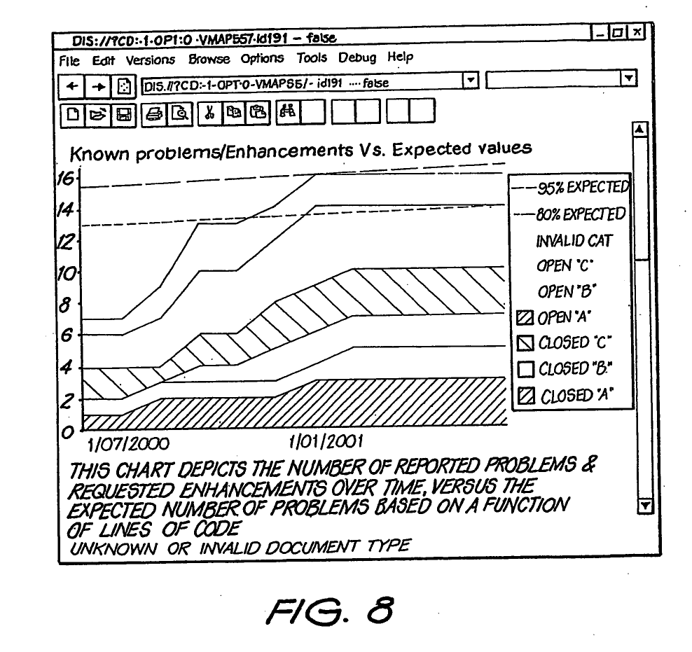

A preferred output for the management system of first example 30A is in the form of documents either appearing on a computer screen or printed versions thereof as shown generally in FIG. 6.

As illustrated in FIG. 7 each document can appear as an ordinary document as would be viewed in any commercially available word processor. The fact that each document is comprised of a plurality of objects can be hidden at the “human view” level.

In this example the change bar 42 appears as a visible line beside the data corresponding to an object in a document as a result of a change to the object.

FIGS. 8, 9 and 10 show typical graphical output of “metrics” which can be obtained by virtue of the characteristics of the management system 30A, where the tracking of change and the linking of related objects allows the system to generate and capture this data.

### SUMMARY OF EXAMPLE 1

1. Systems according to embodiments of the present invention provides a framework for managing information that is process driven and subject to change. The basis of systems according to embodiments of the present invention is that human users, whether engineers, managers or end users, tend and prefer to communicate using documents to convey information.

2. Traditional computer based document information (a stream of bytes) cannot be usefully analysed by a computer. Documents need to be internally structured if they are to be effectively and efficiently manipulated by computers.

3. In complex systems prone to change, ‘document’ information is highly interrelated. Tracking of the relationships between discrete information contained within documents (and between documents) is critical to understanding and managing such systems.

4. In systems prone to change, controlling and understanding the impact of change is critical.

5. Complex systems also need to be controlled by a process if they are to be handled efficiently and effectively. The modelling of the process in many ways reflects the same issues as the actual application that the process supports, for example it is itself a complex system, that is very structured, interrelated and subject to change.

6. Process models must be flexible in order to support the many different application models that have been devised by engineers based on experience.

7. By maintaining information in structured form, linking relevant information and tracking and controlling change, it is possible to generate two things:

a) a consistent set of information across the process, and

b) a wide range of metrics. These metrics can be generated without doing work additional to that already being carried out on a day-to-day basis by the team. Appropriate metrics are useful to all players, including management, team coordinators and clients.

8. Item 7a permits identification, tracking and responses to relationships and changes which are beyond the capabilities of all but the most exceptional humans and of conventional documentation systems, which do not operate at the element level and which do not establish and maintain relationships by means of a process model. The system does not impose rules regarding what is correct, since clashes are flagged for human intervention and decision.

9. Item 7b permits decisions to be made on the basis of factual and up-to-date information, expediting an efficient and successful conclusion for the relevant interested parties (ie facilitates better management).

Document Information System

Systems according to embodiments of the present invention provide a document like user interface (see FIGS. 6 and 7), in a browser style environment with word processing functionality.

Structured Documents

Information in systems according to embodiments of the present invention is stored in a structured form (objects). Although outwardly a ‘document’ like appearance is maintained, the existence of internal structure permits analysis of the information as well as minimisation of “doubling up” of an input of information. This is illustrated in FIG. 5. This also illustrates how multiple ‘documents’ can share objects and ‘documents’ can be composed of objects generated by queries, etc.

Interrelationship of Information

The relationships between objects can be directly maintained (as shown in FIG. 5 by the dotted lines). The interrelationships between objects are maintained at object granularity. The system of the present invention allows the granularity of objects to be determined by the user of the system, according to the process model adopted and other concerns.

Change Control

All objects are fully versioned and all historical version information is maintained. A new version is generated whenever the content of an object changes.

Links are to a group of versioned objects, therefore baselines, etc, can be maintained independently of the object. This also allows the history of links to be maintained. For example, in FIG. 5 the link between “Requirement 1” and “Test 1” is marked as being possibly inconsistent by check flag 19. The requirement has been changed but the related test has not been checked for consistency. The link is flagged as being potentially inconsistent until such time as it is checked. The flag alerts management to the existence of an issue of potential concern. The number of changes (automatically accrued) alerts management and other parties to potential time and resourcing issues.

Control Process Model

The actual activities carried out are specified by a process model that is defined as part of the system (see FIG. 4). The model used for defining, maintaining and handling change control and linkage of information is identical to that used for the maintenance of the actual process information.

The process model is also linked directly to the actual activities. The process model can also be linked back to the relevant standards. The result is that all objects/elements are stored, updated, and monitored with consistency.

Flexible Process Model

The system of the present invention does not impose a particular process model, but rather an obligation to adopt a process model of some sort. Templates for a number of different process models can be supplied with the system. Further templates can be developed and all templates can be customized. Therefore, it is possible to support a client's process model rather than coercing the use of a specific predefined model. Regardless of the particular process model adopted, the benefits from adoption of a process model necessarily follow (e.g., consistent relationships between objects/elements, generation of metrics.)

Examples of process models that may be supplied include traditional waterfall models and incremental models.

The process model and standards determine the methods used and consequently the structure of the actual tasks as well as the type of information that is collected. It also determines how information is interrelated.

Consistency

The system of the present invention ensures that data, in the form of objects, is held both in its own right (e.g., a requirements item) and in terms of its relationships (e.g., the design consequence of the requirements item plus the test script for the design consequence plus the acceptance criteria for the design and test consequences of the requirement.) At any point the whole of the data relating to a particular matter is consistently internally related, with objects either matching or mutually reinforcing (eg the former sequence of requirements-design-test-acceptance data) or clashing due to a mismatch or disconnect (e.g., if someone forgets to amend a test script following an amendment to a requirement).

This consistency is defined by the process model.

Metrics

Metrics are generated as part of the day-to-day activity of using the system of the present invention. A lot of information is automatically collected, including the change history of objects, the relationship between objects, how much effort has been put into modifying objects and who has been responsible for changes.

Relevant metrics can be generated depending on the nature of the questions being asked, a number of examples of which are shown in FIGS. 8, 9 and 10.

### EXAMPLE 2

With reference to FIG. 11, a management system 50, in accordance with a second example, is illustrated for the purposes of managing a software project which requires programming effort from a large number of engineers 51, each of whom is producing components of a project 52 and which components are interdependent upon the components produced by other engineers 51.

### EXAMPLE 3

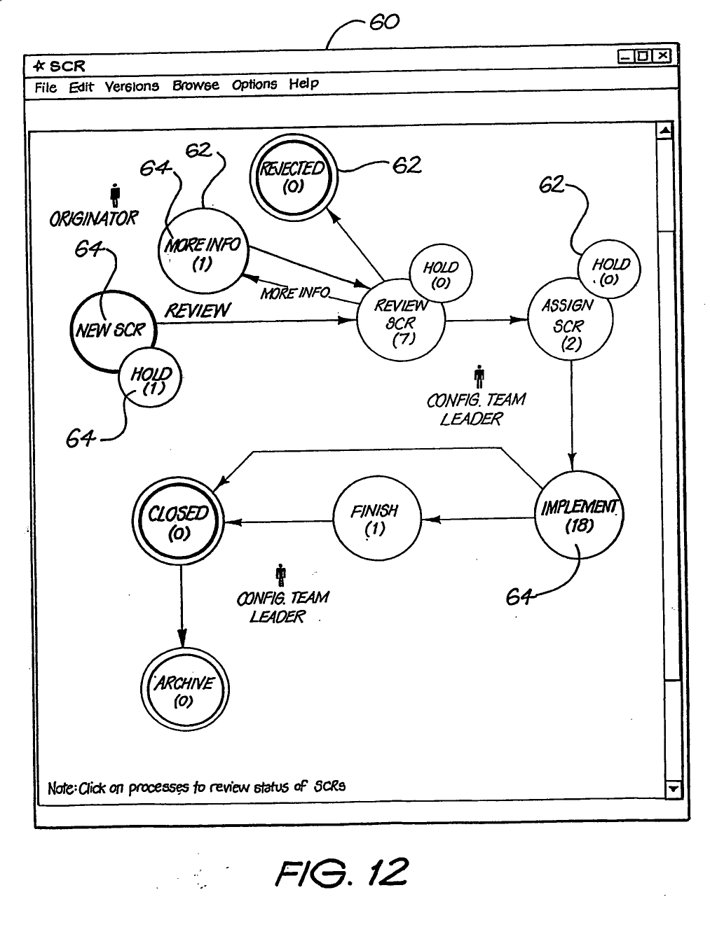

Referring to FIG. 12, a schematic view of a process as defined by an embodiment of the system of the present invention and as presented to a user of the system is shown. In this example, the users of the system are operatives who are responsible for improving and maintaining software in a large distribution system. The software resides in remote facilities which are expensive to access and it is important that changes made in the remote sites are made in a controlled and methodical manner to avoid the need for unnecessary visits to the remote sites.

The process model 60 shown in FIG. 12 is a view of the defined process as presented to a service engineer in the company. Functions of the process are represented as circles 62. The functions are elements of the process being specific activities within the overall process. The service engineer may only initiate activities represented by dark coloured circles 64. The remaining circles are “greyed out” and cannot be accessed but show the overall process. The service engineer initiates an available activity by clicking on a dark circle. For example, if the engineer wishes to change a piece of software at a remote site he clicks “New SCR” indicating that he wishes to initiate a “New Software Change Request”. This brings up a form with specified fields into which the engineer can insert relevant details of the change that he wishes to make. Which fields are made available to the engineer depends upon the definition of the element of the process represented as circle labelled “New SCR” as defined by the management system. The engineer then submits the form. The data that was entered into the available fields of the form is captured as objects and stored in a database. By limiting the available activities, and restricting data entry to pre-defined fields the engineer is confined to operate within the defined process.

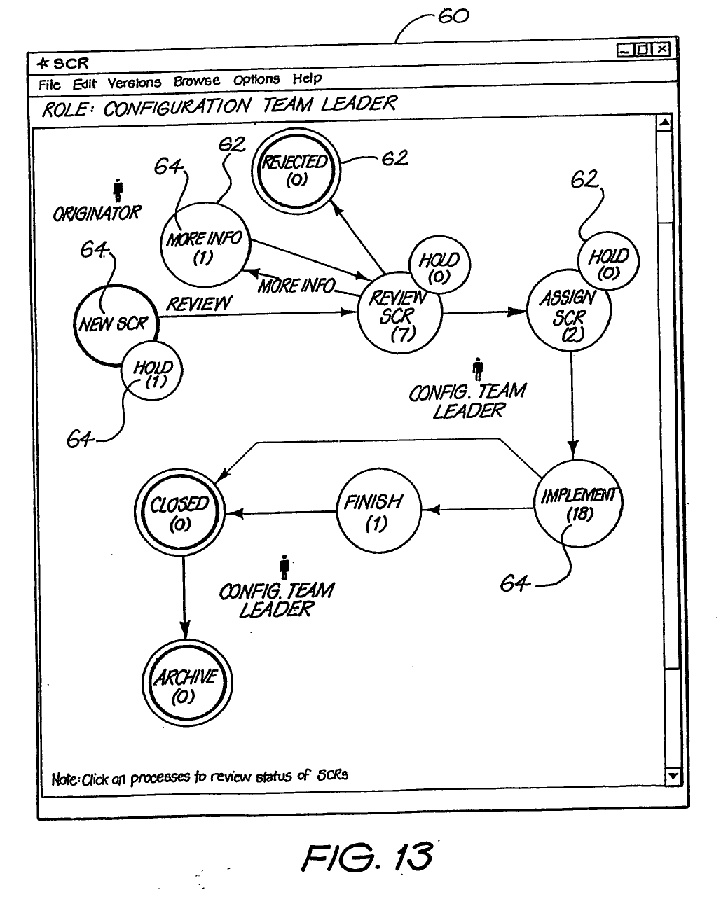

Referring to FIG. 13, a view of the process model 60 of FIG. 12 as presented to a “Configuration Team Leader” is shown. The Team Leader is in charge of reviewing change requests and has wider responsibility. This is reflected in the larger number of activities that are available to the Team Leader indicated by dark circles 64. The number seven in dark circle 64 labelled “Review SCR” indicates that seven “Software Change Requests” have been made that require review by the team leader. The team leader can access these requests to review them by clicking on that dark circle. After reviewing a request the Team Leader decides to assign the request to another person, rejects the request, or requests more information from the originator of the request who in this case is the service engineer. The Team Leader may assign a “Software Change Request” to themselves.

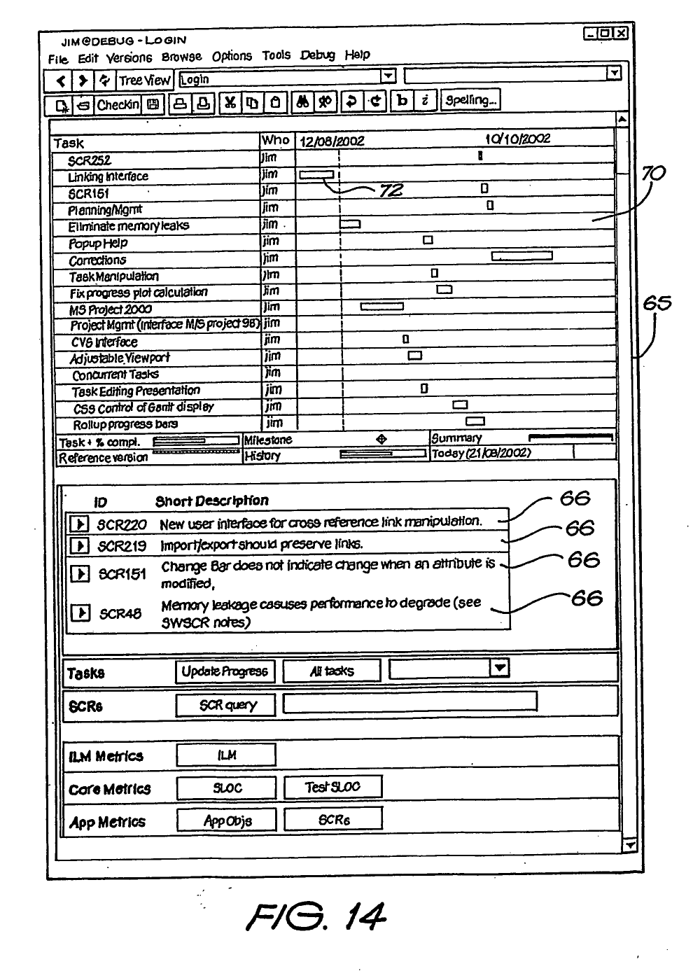

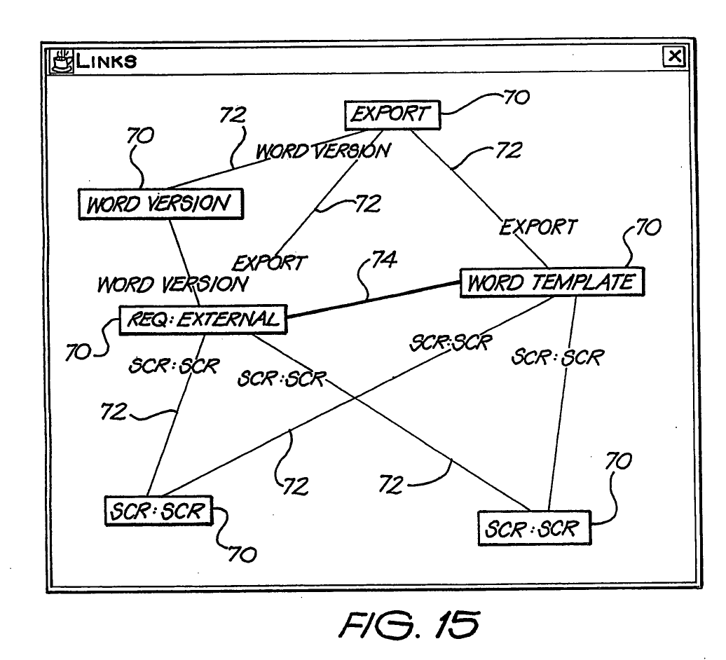

If the Team Leader of this example clicks on the dark circle 64 labelled “Implement” then they are presented with a screen 65 of the kind illustrated in FIG. 14. This screen shows the “Software Change Requests” 66 that are currently assigned to the Team Leader. These “Software Change Requests” may be labelled as tasks 68 and a schedule of tasks 70 is maintained. A progress bar 72 used to represent how much progress has been made in completing a task and over what time period this progress has been made.

By managing the activities of the employees of the company in this way, only persons with appropriate responsibility can approve changes. Further, the changes are recorded in a structured fashion and a history of the changes is maintained. The history of changes can later be analysed to derive useful statistical data to improve decision making in the company.

Referring to FIG. 15, a schematic view of a process as defined and represented to a user by another embodiment of the present invention is shown. The process includes elements 70 and links 72. The elements 70 are defined as objects 11,12 in accordance with FIG. 1. The links 72 are defined by the relationship data 14 (see FIG. 1) of an object. Highlighted link 74 indicates to a user that a change has been made which needs to be reviewed. A check flag 19 (see FIG. 2) causes the link 74 to be represented in a highlighted fashion.

While this invention has been described with reference to managing a project which includes a number of software engineers producing a software product, it has application beyond this. The invention may be used to manage operation of a wide range of processes or systems across a broad range of industrial fields. It could be used for the management of programs of work involving many projects.

It will be appreciated that embodiments of the invention are carried out by operation of a computer system operating under the instruction of appropriately configured software.

The above describes only some embodiments and examples of the present invention and modifications, obvious to those skilled in the art, can be made thereto without departing from the scope and spirit of the present invention.

1-18. (canceled)

19. A method of managing a project including the steps of:
preparing project documentation being made up of a number of discrete elements with relationships between the elements;
carrying out the project in accordance with the project documentation and making changes to the project documentation to reflect actual progress or changes to the project;
when a change is made to the project documentation, consequential changes to elements of the project documentation are made according to the relationships and the previous version of the changed elements are stored; and
analyzing the elements and previous versions of elements to provide management information regarding the progress of the project.

20. The method according to claim 19, wherein the project documentation defines a process that dictates the actual tasks to be carried out in the project.

21. The method according to claim 19, wherein the relationships define whether the changes to the other elements must be reviewed by a human operator.

22. The method according to claim 19, wherein the elements are stored as objects which include attributes.

23. The method according to claim 19, wherein the relationships are stored as an attribute of an object.

24. The method according to claim 19, wherein the step of carrying out the project further includes the step of confining a user to undertaking activities in line with their responsibilities in the project.

25. The method according to claim 19, wherein the step of carrying out the project further includes the step of confining a user to modify only certain elements of the project documentation.

26. The method according to claim 19, further including the step of representing the management information statistically, numerically or in a graphical format.

27. The method according to claim 19, wherein the management information is based on the change history of the elements.

28. The method according to claim 19, wherein the management information is based on changes to the relationships.

29. The method according to claim 19, wherein the management information is based on the effort that has been put into modifying particular elements.

30. The method according to claim 19, wherein the management information is based on the identity of the person involved with the project that has been responsible for making changes.

31. The method according to claim 19, wherein the management information is based on identifying trends over time.

32. The method according to claim 19, wherein the management information is based on known time spent on tasks compared to expected time spent.

33. The method according to claim 19, wherein the management information is based on the project documentation as it stood at a particular point in time.

34. A system for managing a project including:
means for preparing project documentation being made up of a number of discrete elements with relationships between the elements;
means for making changes to the project documentation to reflect actual progress or changes to the project;
means for making consequential changes to elements of the project documentation according to the relationships;
storage means for storing the previous version of the changed elements; and
analyzing means for analyzing the elements and previous versions of elements to provide management information regarding the progress of the project.

35. The system according to claim 34, wherein the project documentation defines a process that dictates the actual tasks to be carried out in a project.

36. The system according to claim 34, wherein the relationships define whether the changes to the other elements must be reviewed by a human operator.

37. The system according to claim 34, wherein the storage means is arranged to store the elements as objects which include attributes.

38. The system according to claim 34, wherein the storage means is arranged to store the relationships as attributes of objects.

39. The system according to claim 34, further including confining means for confining a user to undertaking activities in line with their responsibilities in a project.

40. The system according to claim 34, further including confining means for confining a user to modify only certain elements of the project documentation.

41. The system according to claim 34, further including representing means for representing the management information statistically, numerically or in a graphical format.

42. The system according to claim 34, wherein the analyzing means is arranged to provide management information based on the change history of the elements.

43. The system according to claim 34, wherein the analyzing means is arranged to provide management information based on changes to the relationships.

44. The system according to claim 34, wherein the analyzing means is arranged to provide management information based on the effort that has been put into modifying particular elements.

45. The system according to claim 34, wherein the analyzing means is arranged to provide management information based on the identity of the person involved with the project that has been responsible for making changes.

46. The system according to claim 34, wherein the analyzing means is arranged to provide management information based on identifying trends over time.

47. The system according to claim 34, wherein the analyzing means is arranged to provide management information based on known time spent on tasks compared to expected time spent.

48. The system according to claim 34, wherein the analyzing means is arranged to provide management information based on the project documentation as it stood at a particular point in time.

49. A computer software program arranged to instruct a computing system to operate in accordance with a method according to claim 19.

50. The computer software program arranged to instruct a computing system to operate as a system according to claim 34.

51. The computer readable medium carrying a computer software program in according with claim 49.

52. The computer readable medium carrying a computer software program in according with claim 50.

53. A system for managing a system or process including:
means for defining the system or process as a number of discrete elements;
means for defining relationships between the elements;
means for changing other elements according to the defined relationships when a change is made to an element of the system or process, or a further element is added; and
storing means for storing the previous version of an element when the element is changed.

54. A method of managing a system or process including the steps of:
defining the system or process as a number of discrete elements;
defining relationships between the elements;
changing the other elements according to the defined relationships when a change is made to an element of the system or process, or a further element is added; and
storing the previous version of an element when an element is changed.
